(19) United States
(12) Patent Application Publication
(10) Pub. No.: US 2010/0236250 A1
(43) Pub. Date: Sep. 23, 2010

(54) COMBUSTION CHAMBER BRAZED WITH CERAMIC INSERTS

(76) Inventors: Paul Headland, Lincoln (GB); Michael Turnbull, Broughton (GB)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 12/728,541

(22) Filed: Mar. 22, 2010

(30) Foreign Application Priority Data
Mar. 23, 2009 (EP) 09004127.8

(51) Int. Cl. F23R 3/42; F02C 7/00

(52) U.S. Cl. 60/753; 431/159

(57) ABSTRACT

A housing for a combustion chamber assembly is provided. The housing includes a wall device made of metal material, and an insert device made of ceramic material. The insert device is attached to the wall device such that the insert device forms a part of an inner wall of the housing and the wall device forms an outer wall of the housing.

### CROSS REFERENCE TO RELATED APPLICATIONS

This application claims priority of European Patent Office Application No. 09004127.8 EP filed Mar. 23, 2009, which is incorporated by reference herein in its entirety.

### FIELD OF THE INVENTION

The present invention relates to a housing for a combustion chamber assembly and a method of producing a housing for a combustion chamber assembly.

### ART BACKGROUND

In combustion chamber assemblies the combustion chamber and the combustion pre-chamber are exposed to heat during engine operation. Conventional combustion chamber assembly components are made of metal material, so that the heat during turbine operation leads to abrasion of the metal material. Moreover, streaming of a fluid inside of a combustion chamber assembly may be turbulent, so that a high heat will be exposed to the metal components.

In conventional designs of combustion chamber assemblies a compressor may be used to discharge air and thus to wash the outer skin of the combustion chamber assembly in order to reduce the metal temperature within acceptable limits for the component life.

JP 10 10 36 74 A discloses a combustion for a gas turbine wherein a dome part is formed of metal and a separate cylindrical part on the downstream side of the dome is formed of ceramic.

US 2006/0010879 A1 discloses a mounting of a turbine nozzle on a combustion chamber having CMC walls (CMC: ceramic matrix composite) in a gas turbine. A turbine nozzle connected to a combustion chamber may be formed of ceramic material.

WO 2007/066052 discloses a joint between a metal part and a ceramic part based on SiC and/or C (SiC: chemical formula for “silicon carbide”; C: chemical element “carbon”). A metal part and a ceramic part may be joined together wherein a first spacer and a second spacer separates the metal part and the ceramic part.

### SUMMARY OF THE INVENTION

It may be an object of the present invention to provide a proper housing for a combustion chamber assembly for a turbine.

In order to achieve the object defined above, a housing for a combustion chamber assembly and a method of producing the housing according to the independent claims are provided.

According to a first exemplary embodiment of the present invention, a housing for a combustion chamber assembly is provided. The housing comprises a wall device made of metal material and an insert device made of ceramic material. The insert device is attached to the wall device in such a way that the insert device forms a part of an inner wall of the housing and the wall device forms an outer wall of the housing.

According to a further exemplary embodiment, a method of producing the above-described housing is provided. The method comprises the step of attaching the insert device to the wall device in such a way that the insert device forms a part of an inner wall of the housing and the wall device forms an outer part of the housing.

The combustion chamber assembly may comprise for instance a pilot burner body, a combustion pre-chamber, a mixing tube and/or a combustion chamber. Each of the elements of the combustion chamber assembly may comprise a separate housing according to the above mentioned exemplary embodiment, i.e. a housing comprising the wall device made of metal and the insert made of ceramic material. Besides that, the combustion chamber assembly may comprise one common above mentioned housing as denoted above.

The wall device may form the outer wall of the housing, wherein to the inner surface of in the interior side of the housing the insert device may be attached. Because the insert device may be made of ceramic material, an improved heat resistance in comparison to the metal material is achieved.

The metal material may comprise all sorts of steel and metal alloys, e.g. Haynes alloys or Nimonic alloys.

The ceramic material may comprise all sorts of silicate components, preferably Silicon nitride (Si₃N₄) and SiAlON (alumina substituted into silicon nitride), Aluminium nitride (AlN) and Boron nitride (BN). Furthermore, the ceramic material may also comprise Alumina (aluminium oxide, Al₂O₃), Zirconia (zirconium oxide, ZrO₂), Tungsten carbide (WC), Boron carbide (B₄C) and Silicon carbide (SiC).

By the present invention, an inner side of the housing may be made of an insert device made of ceramic material, so that a proper heat resistance may be provided in comparison to metal material. Compressor discharged air for cooling the metal material may be not longer necessary because the metal material of the outer wall device is not longer exposed directly to the heat inside of the combustion chamber assembly. Thus, without the compressor discharged air, the outer skin respectively the wall device made of metal material may be kept within acceptable temperature limits, so that the component life may be improved. Further expensive cooling devices, such as air compressors, may be not longer necessary.

The insert device may be attached to the inside of the wall device in such a way, that the housing provides a hybrid design. With other words, the insert device may be attached directly with e.g. fully contact, to the inside of the wall device.

Due to the ceramic insert, the housing may be temperature resistant without applying temperature protecting coatings (e.g. MCrAlly coatings) to the inner wall of the housing. In conventional housing the temperature protecting coatings may go off easily from the inner wall, so the inner wall have to be coated again after short operating periods. This may lead to shorter maintenance periods, so that maintenance costs may be reduced.

According to a further exemplary embodiment of the present invention, the insert device and the wall device are brazed together. By brazing the insert device to the wall device, a rigid and fixed connection may be provided. By brazing the insert device and the wall device together, between the insert device and the wall device no air leakage may occur, so that a reduction in the occurrence of hot gas leakage to atmosphere may be provided and the safety may be improved.

According to a further exemplary embodiment of the present invention, the wall device comprises force transmitting elements, wherein the force transmitting elements are adapted for transmitting bearing force of the wall device to adjacent components. I.e. the bearing force or the supporting force is supported only by the wall device, so that a reduced tension and stress caused by bearing forces will transferred to the insert device. Thus, the defect of the ceramic material of the insert device may be reduced because the ceramic material is in general not capable to be exposed to bending moments or tension forces. On the other side, the metal material of the wall device is qualified for transmitting such forces. Thus, the qualification of each material, namely of the metal material and the ceramic material, are applied due to its qualifications and characteristics, so that the lifetime of the housing may be improved. I.e. the insert device is applied for preventing an overheat of the wall device made of metal material, and the wall device is applied for transmitting the mechanical load for reducing stress and tensions in the insert element.

The transmission of the mechanical load respectively the bearing force may be provided by the force transmitting elements. The force transmitting elements are attached to the wall device or are formed with the wall device. The force transmitting elements may be for instance a flange, a screw hole or other elements adapted for connecting the housing to another adjacent part or carriers.

Summarizing, by the exemplary embodiment, the larger part of force flow that is caused by the supporting of the housing is guided over the wall device and no part or a reduced part of the force flow is transferred to the insert device. Thus, an improved utilization of the best characteristics of each material, respectively metal material and the ceramic material, may be provided by the (hybrid) housing.

According to a further exemplary embodiment of the present invention, the wall device comprises a cooling opening. When providing cooling openings in the wall element, a cooling fluid, such as air or other hydraulic fluids, may be used for direct cooling of the ceramic insert. Thus, the ceramic material of the insert device may stand higher temperatures of the inner fluid and additionally the wear of the ceramic material may be reduced. The cooling openings may be provided by a hole or grooves in the wall device, for example.

According to a further exemplary embodiment, the insert device is attached to the wall device in a detachable manner. Thus, when the ceramic insert is damaged for instance due to wear or due to high temperature, the insert device may be detached, machined out and exchanged by a further insert device. Thus, it is not necessary to exchange the wall device respectively the whole housing when a damage of the insert device is occurred. Thereby, maintenance costs may be reduced. Moreover, the insert device may be machined out and re-applied, without the need of scraping off the housing.

According to a further exemplary embodiment of the present invention, the insert device comprises engagement elements, wherein the engagement elements are adapted for being mechanically coupled with an exchanging tool. The engagement elements may comprise grooves or other suitable elements that are adapted for being engaged by an exchanging tool. With other words, the engagement elements are adapted for being coupled to an engaging tool, so that the insert device may be machined out or exchanged from the wall device. The coupling may be provided also for instance by magnetic engagement elements, so that beneath a mechanical coupling also a magnetic coupling with the exchanging tool may be provided.

According to a further exemplary embodiment of the present invention, the insert device comprises a plurality of insert elements. By providing a plurality of insert elements, the thermal growth of the wall element may be compensated by the plurality of insert elements. I.e. in general the metal material provides a higher thermal expansion coefficient in comparison to the ceramic material of the insert device. Thus, when the insert device is rigidly fixed to the wall device, tensions and stress arise between the wall device and the insert device due to the different thermal expansion coefficients. When the insert device comprises a plurality of (separated) insert elements, the insert device is flexible, so that the insert elements move for example away from each other when the metal material of the wall device expands. In other words, by splitting up the insert device in separate insert elements, thermal growth mismatches are allowable. Moreover, the crack growth of the insert elements is advantageously restricted to one insert element. Thus, when a crack growth occurs in one insert element, the other insert element remains stable and undamaged. Thus, the lifetime of the overall insert device may be improved. Moreover, when a defect of an insert element occurs, only the damaged insert element may be replaced, so that the maintenance costs may be reduced.

According to a further exemplary embodiment, a combustion pre-chamber comprising the above described housing is described. The wall device forms an outer wall of the combustion pre-chamber, wherein the profile of the outer wall is cylindrically. The insert device faints a part of the inner wall of the combustion pre-chamber, wherein the profile of the inner wall is cylindrically. With other words, the housing of the present exemplary embodiment is a combustion pre-chamber that is located in the combustion chamber assembly between e.g. a swirler and a dome part. The dome part and the swirler may be made of metal material. Besides the cylindrical shape of the combustion pre-chamber, a cubic or rectangular shape may also be appreciable.

According to a further exemplary embodiment of the present invention, a pilot burner device comprising the above described housing is described. The wall device forms the outer wall of the pilot burner device. The insert device forms the part of the inner wall of the pilot burner device. The part of the inner wall of the pilot burner device comprises a pilot burner face. The pilot burner is adapted for igniting the flame into the combustion chamber assembly. The pilot burner body is e.g. attached to the tubular combustion chamber. Thus, the pilot burner forms a part of the housing of the combustion chamber assembly. The wall device respectively the pilot burner outer wall is made of metal material in order to provide proper supporting characteristics and to keep the costs of the part down. At the ignition area of the pilot burner device, the pilot burner face is located. The area of the pilot burner face may consist of the inner wall of the pilot burner device including the insert device made of ceramic material. Thus, in the hottest area of the pilot burner device, a ceramic material may be attached to, so that the lifetime of the pilot burner device may be improved.

In conventional pilot burners, the pilot burner bodies are made of metal which is a compromise material to keep the costs of the part down and to provide some resistance to the temperature. The pilot burner face provides for instance a MCrAlly coating to keep the metal temperature within acceptable limits for component life.

By the present invention, by adding a ceramic insert device into the wall device made of metal, the ceramic insert device protects the outer metal wall device from excessive temperature. Both, the insert device and the wall device may be connected by brazing. The insert device and the wall device may form thereby a hybrid housing. In particular, the insert device may be attached directly without any further intermediate layers to the wall device. The manufactured (hybrid) housing, respectively the combination of the insert device attached to the wall device, faun e.g. a combustion pre-chamber of the combustion chamber assembly. Such a combustion pre-chamber may be located between a swirler device and a dome of the combustion chamber assembly. The housing may be attached to other parts of the combustion chamber assembly, such as the swirler device or the dome, e.g. by joint connection or flange connections. A brazing of the housing respectively of the wall device to other parts of the combustion chamber assembly for supporting the housing may not be necessary. I.e. the larger part of the bearing load is transferred through the wall device, respectively the outer metal sleeve. Thus, only a small part of the load is transferred through the ceramic insert device, so that the risk of damage, e.g. of crack growth, may be reduced. Moreover, cooling openings in the metal wall device provides a better heat transfer directly from the ceramic insert device to the environment respectively to the air cavity.

Thus, the embodiments of the present invention provides a more robust housing for a combustion chamber assembly that is in particular more robust to excessive temperatures especially during liquid operation, i.e. when liquid fuel spray hitting the inner wall respectively to the insert device of the housing. In comparison to the use of metal material, the hot liquid fuel spray hitting a metallic wall would lead to metal loss and distortion.

It has to be noted that embodiments of the invention have been described with reference to different subject matters. In particular, some embodiments have been described with reference to apparatus type claims whereas other embodiments have been described with reference to method type claims. However, a person skilled in the art will gather from the above and the following description that, unless other notified, in addition to any combination of features belonging to one type of subject matter also any combination between features relating to different subject matters, in particular between features of the apparatus type claims and features of the method type claims is considered as to be disclosed with this application.

### BRIEF DESCRIPTION OF THE DRAWINGS

The aspects defined above and further aspects of the present invention are apparent from the examples of embodiment to be described hereinafter and are explained with reference to the examples of embodiment. The invention will be described in more detail hereinafter with reference to examples of embodiment but to which the invention is not limited.

FIG. 1 shows a schematical view of a housing for a combustion chamber assembly according to an exemplary embodiment of the invention;

FIG. 2 illustrates a schematical view of a housing comprising insert elements according to an exemplary embodiment of the invention;

FIG. 3 illustrates a schematical view of the housing comprising cooling openings and force transmitting elements according to an exemplary embodiment of the invention;

FIG. 4 illustrates a combustion chamber assembly comprising a combustion chamber and a combustion pre-chamber according to an exemplary embodiment of the present invention;

FIG. 5 illustrates a schematical view of a pilot burner device; and

FIG. 6 illustrates an overview of a combustion chamber assembly comprising several housing elements according to an exemplary embodiment of the invention.

### DETAILED DESCRIPTION

The illustrations in the drawings are schematically. It is noted that in different figures, similar or identical elements are provided with the same reference signs.

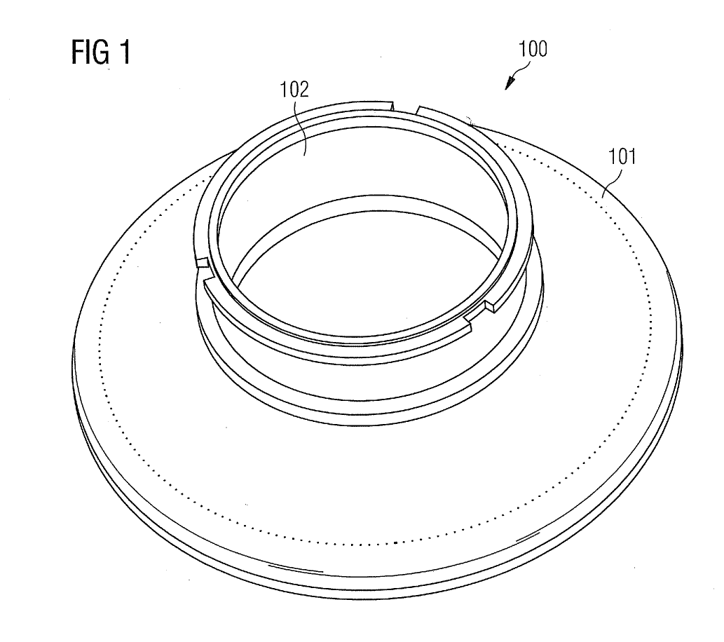

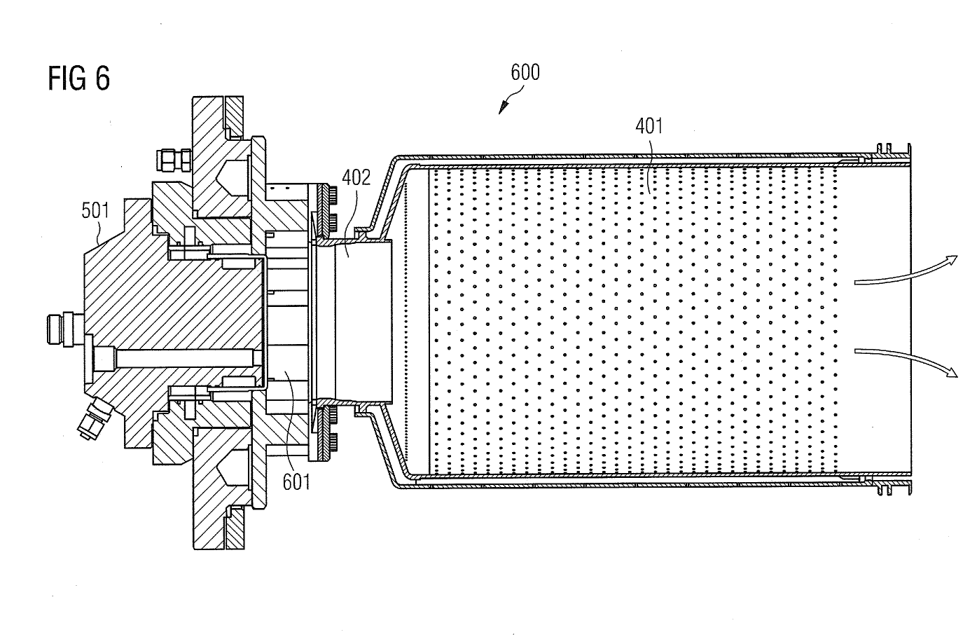

FIG. 1 shows a housing 100 for a combustion chamber assembly 600 (see FIG. 6). The housing comprises a wall device 101 made of metal material and an insert device 102 made of ceramic material. The insert device 102 is attached to the wall device 101 in such a way, that the insert device 102 forms a part of an inner wall of the housing 100 and the wall device 101 fauns an outer wall of the housing 100.

“Inner” and “outer” is defining the direction to which a wall is directed. “Inner” wall is directed to the centre of a combustion chamber. Hot fluid will pass directly at the surface of the inner wall. “Outer” wall defines a wall directed away from the centre of the combustion chamber.

Thus, the hot fluid flow inside of the tube is only exposed to the insert device 102 made of ceramic material. The wall device 101 made of metal material is for instance not completely exposed to the hot fluid flow inside the housing. Thus, the resistance to temperature of the ceramic material of the insert device 102 is better in comparison to the metal wall device 101, so that the lifetime of the housing 100 may be improved.

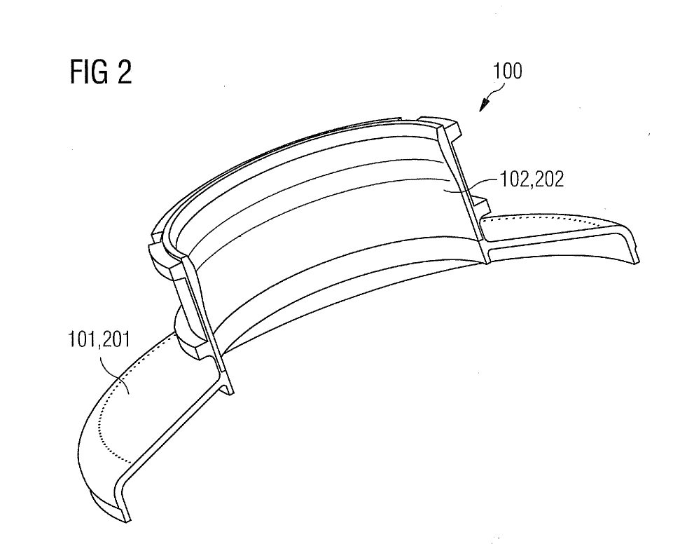

FIG. 2 shows a sectional view of the housing 100, wherein the wall device 101 comprises a plurality of wall elements 201 and the insert device 102 provides a plurality of insert elements 202. The insert elements 202 may be attached separately from each other and form together the insert device 102. Thus, when a crack growth in one insert element 202 occurs, the crack growth will stop at the gap between the insert elements 202. Thus, when crack growth occur, only a part of the insert device 102, respectively only the effected insert element 202, will be damaged. Moreover, only a partial exchange of the insert elements 202 may be necessary for maintenance purposes. Moreover, to improve the maintenance and the lifetime of the housing 100, the insert device 102 as well as the insert elements 202 may be attached to the wall device 101 in a detachable manner.

The insert device 102 respectively the insert element 202 may be attached to the wall device 101 for instance by brazing gluing or by a press-fitting.

As an example, two insert elements 202 may form a complete insert device 102, in which each insert element 202 may be roughly a half tube. In FIG. 2 the second insert element 202 is not shown. Furthermore, several insert elements 202 can be present, all of the being a fraction of a tube and together forming a complete insert device 102.

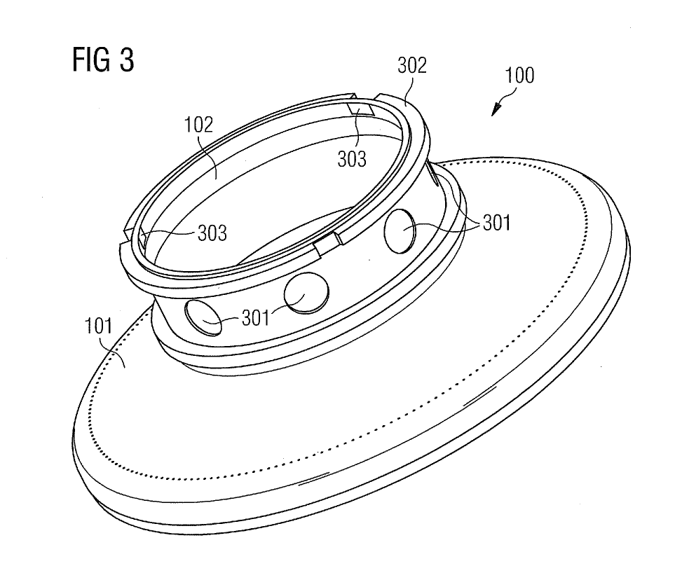

FIG. 3 illustrates a housing 100 wherein the wall device 101 provides cooling openings 301 and force transmitting elements 302. Moreover, the insert device 102 comprises engagement elements 303.

When providing cooling openings 301 in the wall device 101 the heat exchange of the ceramic insert device 102 with the environment may be improved. Through the cooling openings 301 an outside surface of the insert device 102 may be cooled. Thus, the temperature within the housing may be kept in acceptable limits without providing complex cooling devices that would lead to a higher energy consumption and thus to higher operating costs.

Moreover, the force transmitting elements 302 are shown in FIG. 3, wherein by the force transmitting elements 302 the housing 100 may be supported or may be attached to other parts of the combustion chamber assembly 600. Thus, the major part of the load (supporting load) of the housing 100 is transferred through the wall device 101 and no part or only a minor part of the load is transferred through the insert device 102. Thus, stress caused by load may be reduced at the insert device 102 or at the insert element 202. The force transmitting elements 302 may comprise a flange, a thread, a sleeve or a connection edge. Also other force transmitting elements 302 may be applicable that are adapted for transferring a (supporting) load force from the housing 100 or the wall device 101 to other (adjacent) parts of the combustion chamber assembly 600.

Moreover, FIG. 3 shows engaging elements 303 of the insert device 102. The engagement elements 303 may comprise grooves in the insert device 102 for providing a coupling with an exchanging tool for a better machining out and decoupling of the insert device 102 with the wall device 101. Moreover, the engagement elements 303 may comprise magnetic elements for providing a magnetic coupling to the exchanging tool.

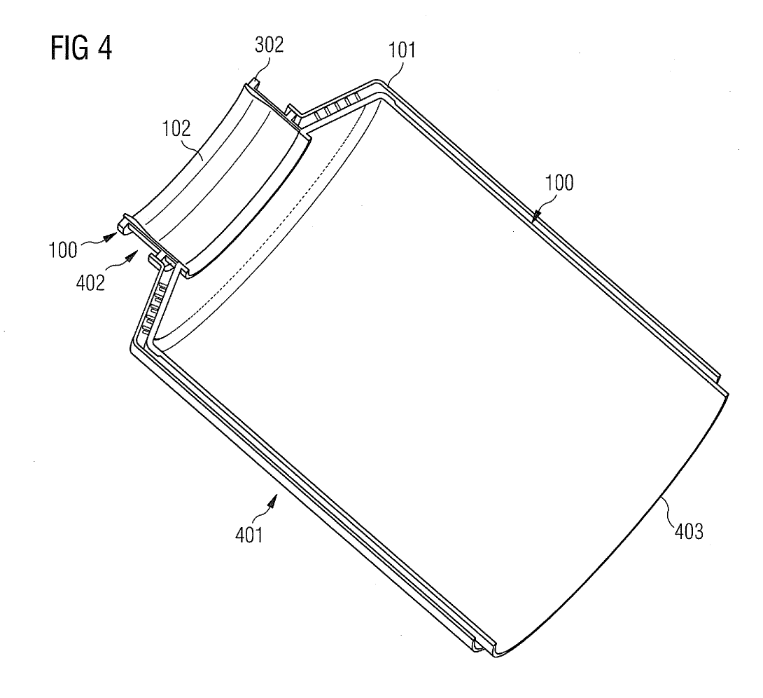

FIG. 4 illustrates a combustion chamber 401 and a combustion pre-chamber 402 of a combustion chamber assembly 600 (see FIG. 6). The combustion chamber 401 may comprise a housing 100 and the combustion pre-chamber 402 may comprise a further housing 100. Both housings 100 of the combustion chamber 401 and the combustion pre-chamber 402 may be separate housings 100 combined detachably with each other or both, the combustion chamber 401 and the combustion pre-chamber 402 comprise one common housing. A part of the insert device 102—located in the area of the pre-chamber 402—or a part of a further insert device 403—located in the area of the combustion chamber 401—may overlap with the wall device 101. With the force transmitting elements 302, as shown in FIG. 4 by a flange, a connection to adjacent parts of the combustion chamber assembly 600 may be provided, wherein the load respectively the supporting load may be guided through the wall device 101 and not through the insert device 102.

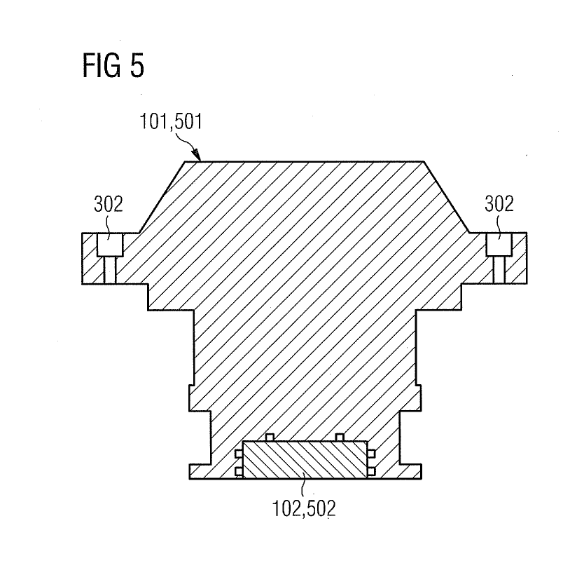

FIG. 5 illustrates via a sectional view a pilot burner device 501 and a pilot burner face 502 which both are basically, with possibly some exceptions, rotational symmetric. The pilot burner device 501 forms the wall device 101. The pilot burner device 501 may comprise the force transmitting elements 302 for attaching the pilot burner device 501 to other parts of the combustion chamber assembly 600. To the inner wall of the pilot burner device 501 the pilot burner face 502 is located facing in the direction of the combustion chamber. At the pilot burner face 502 a flame of the combustion chamber assembly 600 may be ignited, so that at the location of the pilot burner face 502 high temperature may occur. Thus, when providing the pilot burner face 502 as the insert device 102, the insert device 102 may stand higher temperatures because the insert device 101 is made of ceramic material.

FIG. 6 illustrates an overview of a combustion chamber assembly 600. The combustion chamber 401 and the combustion pre-chamber 402 are formed tubular respectively cylindrical. To one side respectively to the combustion pre-chamber 402, the pilot burner device 501 is attached to. The pilot burner device 501 closes the tubular combustion chamber 401 respectively combustion pre-chamber 402 at the upstream side (stream direction indicated by the arrows). Between the pilot burner device 501 and the combustion pre-chamber 402 a swirler device 601 may additionally attached.

It should be noted that the term “comprising” does not exclude other elements or steps and “a” or “an” does not exclude a plurality. Also elements described in association with different embodiments may be combined. It should also be noted that reference signs in the claims should not be construed as limiting the scope of the claims.

1.-10. (canceled)

11. A housing for a combustion chamber assembly, comprising:
a wall device made of metal material; and
an insert device made of ceramic material,
wherein the insert device is attached to the wall device such that the insert device forms a part of an inner wall of the housing and the wall device forms an outer wall of the housing.

12. The housing according to claim 11, wherein the insert device and the wall device are brazed together.

13. The housing according to claim 11,
wherein the wall device comprises force transmitting elements, and
wherein the force transmitting elements are adapted for transmitting bearing force of the wall device.

14. The housing according to claim 12,
wherein the wall device comprises force transmitting elements, and
wherein the force transmitting elements are adapted for transmitting bearing force of the wall device.

15. The housing according to claim 11, wherein the wall device comprises a cooling opening.

16. The housing according to claim 14, wherein the wall device comprises a cooling opening.

17. The housing according to claim 11,
wherein the insert device is attached to the wall device in a detachable manner.

18. The housing according to claim 17,
wherein the insert device comprises engagement elements, and
wherein the engagement elements are adapted for being mechanically coupled with an exchanging tool.

19. The housing according to claim 11, wherein the insert device comprises a plurality of insert elements.

20. The housing according to claim 18, wherein the insert device comprises a plurality of insert elements.

21. A combustion pre-chamber, comprising:
a housing with
a wall device made of metal material, and
an insert device made of ceramic material, the insert device being attached to the wall device,
wherein the wall device font's an outer wall of the combustion pre-chamber, the profile of the outer wall being cylindrically, and
wherein the insert device forms a part of the inner wall of the combustion pre-chamber, the profile of the inner wall being cylindrically.

22. The combustion pre-chamber according to claim 21, wherein the insert device and the wall device are brazed together.

23. The combustion pre-chamber according to claim 21,
wherein the wall device comprises force transmitting elements, and
wherein the force transmitting elements are adapted for transmitting bearing force of the wall device.

24. The combustion pre-chamber according to claim 21, wherein the wall device comprises a cooling opening.

25. The combustion pre-chamber according to claim 21,
wherein the insert device comprises engagement elements, and
wherein the engagement elements are adapted for being mechanically coupled with an exchanging tool.

26. A pilot burner device, comprising:
a housing with
a wall device made of metal material, and
an insert device made of ceramic material, the insert device being attached to the wall device,
wherein the wall device forms an outer wall of the pilot burner device,
wherein the insert device forms a part of the inner wall of the pilot burner device, and
wherein the part of the inner wall of the pilot burner device comprises a pilot burner face.

27. The pilot burner device according to claim 26, wherein the insert device and the wall device are brazed together.

28. The pilot burner device according to claim 26,
wherein the wall device comprises force transmitting elements, and
wherein the force transmitting elements are adapted for transmitting bearing force of the wall device.

29. The pilot burner device according to claim 26, wherein the wall device comprises a cooling opening.

30. The pilot burner device according to claim 26,
wherein the insert device comprises engagement elements, and
wherein the engagement elements are adapted for being mechanically coupled with an exchanging tool.
